(19) United States
(12) Patent Application Publication
(10) Pub. No.: US 2008/0205692 A1
(43) Pub. Date: Aug. 28, 2008

(54) Method and Kit for Determining Consumer Preferences

(76) Inventors: Chad Hinkle, Kettering, OH (US); Lois Hinkle-Coleman, Mason, OH (US)

Correspondence Address: HASSE & NESBITT LLC, 8837 CHAPEL SQUARE DRIVE, SUITE C, CINCINNATI, OH, 45249, US

(21) Appl. No.: 11/678,707

(22) Filed: Feb. 26, 2007

(51) Int. Cl. G06K 9/00

(52) U.S. Cl. 382/100

(57) ABSTRACT

A method and kit for determining consumer preferences and desires for a product line or service, utilizing images which symbolize archetypes and/or represent emotional drivers of human behavior. Images are used to determine consumer preferences for product lines or services by examining Respondents' psychological framework to reveal the “must have” emotional components for a product or service. Since the Respondent typically is not able to explain exactly what their preferences are as consumers, the use of the present invention provides symbology to allow them to reveal their inarticulable preferences for a product or service.

### FIELD OF THE INVENTION

This invention relates to the field of human behavior and, more particularly, to a method and kit for use in determining the preferences of consumers for a product line or service through the use of symbolic images.

### BACKGROUND OF THE INVENTION

A key goal of most businesses is to target consumers with products and services that are of interest to the consumer based on their interests, desires, preferences, or demographics. Thus many attempts have been made to determine consumer's interests and provide promotions or advertisements for products and services that match such interests. A great deal of time and effort goes into compiling marketing information regarding individuals, groups, regions and all sorts of demographic categories. This information is generally obtained by surveying the targeted subjects about their buying behavior or preferences. While surveys produce reasonably accurate results, they are costly and time consuming, and there is no guarantee of accuracy. Thus, a reliable method of determining consumer preferences is needed that indicates a reliable preference for a product. Such a method would be an extremely valuable tool for marketers.

The use of archetypes to analyze human personality was advanced by Dr. Carl G. Jung early in the 20th century, and generally adopted in the social sciences. In common parlance, an archetype can be defined as a prototype, or an original model or type after which other similar things are patterned. For example, Frankenstein and Dracula are classic symbols of horror story archetypes that have influenced subsequent horror stories. Symbols representing archetypes have been present in mythology and literature for hundreds of years. In Jung's psychological framework, archetypes are defined as an inherited pattern of thought or symbolic imagery, derived from the past collective experience and present in the individual unconscious. In Jungian psychology, a symbol representing an archetype may be used to interpret observations. Research done by Dr. Jung found symbols for archetypes present in myths, stories, artwork and daily lives of past and present cultures all around the world. Symbols which represent archetypes have powerful effects on thoughts, decision-making and behaviors. The same interpretation of archetype symbols can be found from individual to individual.

Previous methodologies for determining consumer preferences rely on the consumer to verbally, or in a questionnaire, report the type and quality of products that they prefer. For example, U.S. Pat. No. 5,041,972 to Frost discloses a method for performing marketing research by conducting consumer interviews and evaluating their responses. U.S. Pat. No. 6,332,129 to Walker et al. discloses a system which utilizes a psychographic questionnaire to efficiently increase the rate of sales based on buyer's needs and purchasing patterns.

Although the above methodologies may be useful for their intended purposes, consumer preferences can often be non-articulable. Thus, in typical prior art consumer focus groups, surveys or questionnaires, the consumer typically articulates their wants or desires in the form of rational logic. There is currently no system or method which can reliably reveal the inarticulable, hard-wired emotional drivers of human behavior, as they pertain to consumer preferences and desires for product lines or services.

### SUMMARY OF THE INVENTION

In light of the foregoing, it would be advantageous to provide a method for determining consumer preferences and desires for product lines or services by utilizing a standard set of images or symbols representing emotional drivers of human behavior.

The present invention uses psychology and symbology to study how human beings use metaphors and language (i.e. symbols) to communicate meaning to others, and provides a method for revealing innate emotional drivers of human behavior by using archetypes and symbolic images, and applying these emotional drivers to determine consumer preferences. The process can also be used as a team building exercise that enables group members to understand each other at a much deeper and more thorough level.

A first aspect of the invention provides a method for determining consumer preferences, the method comprising the steps of: (a) providing a subject for at least one individual to concentrate upon; (b) providing the individual with a set of symbolic images; (c) instructing the individual to quickly sort through the symbolic images and to select images which relate to the subject; (d) instructing the individual to sort through the images selected in step (c) and to select a predetermined number of images which most strongly relate to the subject; (e) assigning each image selected in step (d) to one of a plurality of categories; and (f) determining a dominant category expressed by the individual according to the total number of images assigned to each category in step (e), wherein the dominant category has the most images assigned to it and thereby represents preferences the individual has about the subject.

A second aspect of the invention provides a method for determining consumer preferences for a product line or business service, the method comprising the steps of: (a) providing a subject for at least one individual to concentrate upon; (b) providing the individual with a first set of symbolic images; (c) instructing the individual to quickly sort through the first set of symbolic images and to select images which relate to the subject; (d) instructing the individual to sort through the images selected in step (c) and to select a predetermined number of images which most strongly relate to the subject; (e) assigning each image selected in step (d) to one of a plurality of categories; (f) determining a dominant category expressed by the individual according to the total number of images assigned to each category in step (e), wherein the dominant category has the most images assigned to it and thereby represents preferences the individual has about the subject; (g) providing the individual with a second set of symbolic images; (b) instructing the individual to quickly sort through the second set of symbolic images and to select images which relate to the images selected in step (d); (i) obtaining and documenting verbal observations from the individual regarding each image selected in step (h); and (j) determining a sub-category of the dominant category according to the observations made regarding each image in step (i), wherein the sub-category provides a more detailed understanding of the preferences of the individual about the subject.

A third aspect of the invention provides a kit for use in determining consumer preferences, the kit comprising: (a) a first set of images, each image in the first set of images representing at least one archetype; (b) a second set of images, each image in the second set of images adapted to relate to at least one archetype; and (c) directions for using the set of symbolic images, wherein the kit is used by a moderator trained in marketing and an analyst trained in psychology, and wherein both the moderator and the analyst are familiar with symbology and Jungian Archetypes.

The nature and advantages of the present invention will be more fully appreciated from the following drawings, detailed description and claims.

### DETAILED DESCRIPTION OF THE INVENTION

As used herein, the term “analyst” or “psychological analyst” means a moderator trained in psychology who deciphers Respondents' image choices and observations about their image choices. The analyst then determines the Respondents' preferences regarding a particular directive or subject, and confers with a marketing moderator to make recommendations.

The term “archetype” means a recognized or standard representation of an innate, unconscious memory of a past experience, situation, or individual that compels a person into perceiving and experiencing the world in a distinct, and thus predictable, way. An archetype can be represented by a category, as defined herein.

The terms “category” or “categories” mean a symbol for an archetype. Typically a category/symbol for an archetype can be one of the following: (1) Mother, (2) Father, (3) Child, (4) Hero, (5) Wise Old Man, and (6) Trickster.

The term “dominant symbology” means the category in which the first set of images chosen by the Respondent(s) falls under more often than any other category.

The term “directive” means an instruction, typically given to Respondents by a moderator, which presents a particular subject for consideration.

The phrase “emotional driver” means a non-rational force or tendency which causes an individual to behave in a particular way and/or believe in a particular thing. An emotional driver is, by nature of its irrationality, unable to be put into words.

The term “individual” can be used herein to denote either an individual consumer or a group of consumers, since the method can be applied to either individuals or groups of consumers equally effectively.

The term “moderator” or “marketing moderator” means a person trained in marketing that conducts and oversees the method of the invention. The marketer typically works together with an analyst, and preferably has some knowledge about PsychoSymbology. Typically the moderator determines the directives or questions to be asked to the Respondents, confers with the analyst after the sorts are made and preferences are determined, and then makes recommendations regarding consumer preferences.

The term “observation” means a description or a comment made by an individual about one of the set of symbolic images which the individual selects during use of the method of the invention. Observations typically are recorded in order to place the selected images into a category.

The term “preferences” means the desires, wants, “must haves,” or needs of an individual, as it relates to a particular product, service or subject. Regarding consumer preferences, a preference typically refers to the selecting of one item over another or others.

The terms “sort” or “archetypal sort” means a smaller group of images that has been selected out of a larger group of images by an individual undergoing analysis, according to the present invention. For example, after reviewing an original set of twenty-four images, an individual selects (i.e. sorts) a subset of these images according to directions given them by the moderator. This subset of images is known as the sort.

The term “subject” means a directive, topic, theme or issue to be explored, or a matter under discussion when using the method of the present invention. As a non-limiting example, the subject to be explored can be a product line, a business service, a business group, an event, a location, a word, a phrase, and a feeling.

The term “sub-type” means a sub-category, or a further division of a category, as defined herein. As a non-limiting example, sub-categories of the Child category can be the Mysterious Child, the Wondrous Child, the Overwhelmed Child, and the Mischievous Child.

The term “symbology” means the study of how human beings use metaphors, language, and symbols (i.e. something which stands for something else) to communicate meaning to others.

The present invention uses symbols, or symbology, to determine consumer preferences for product lines or services. A standardized set of images or symbols are used for examining consumers' psychological frameworks in order to reveal the “must have” emotional components for a product or service.

The images or symbols used herein represent archetypes. The invention uses symbols/categories for six primary archetypes, namely: (1) Mother, (2) Father, (3) Child, (4) Hero, (5) Wise Old Man, and (6) Trickster. Working definitions of these six primary archetypes are as follows:

Mother: Some stereotypical examples of the Mother archetype include the Virgin Mary, Mother Theresa, a Female Lioness, and Mother Nature. Positive attributes of the Mother include nurturing, understanding, patience, protecting, and gentleness. Negative attributes of the Mother are that she can be possessive, hyper-vigilant, vengeful, “cold,” and needy. The Mother is typically externally focused and puts her needs last. She typically sees her job as a caregiver and nurturer to those around her. When she takes her duties too far, she can become controlling and extremely worrisome. She can strike out with a vengeance at anyone that she thinks might be coming after her charges or herself, even though this may not have been their intention.

Father: Some stereotypical examples of the Father archetype include the Pope, a sports coach, a male wolf, and the Sun. Positive attributes of the Father include protection, guidance, discipline, hardworking, and determined. Negative attributes are that the Father can be violent, uncaring, self-centered, narrow-minded, and hateful. The Father typically feels responsibility for the survival of others, especially his family. He is intimidating and can use the intimidation to control others. Forcefulness is a double-edged sword, in that it allows the Father to be a creative as well as a destructive force in the world. The Father can be a wonderful resource to others because he is often seen as practical, rational and truthful.

Child: Some stereotypical examples of the Child archetype include the Baby Jesus, Dennis the Menace, Dickens' Tiny Tim, and a butterfly Positive attributes of the Child include spontaneity, creativity, a sense of wonder, innocence, and purity. Negative attributes are ignorance, incredible selfishness, impatience, unpredictability, and fearfulness. The Child is typically a mixture of the appreciation for the novelty of every experience and the unwillingness to see the needs of others. He/she is the personification of the joy and happiness that we seek in life. The Child needs constant monitoring and reassurance, as the world can also be seen/experienced as overwhelming and dangerous.

Hero: Some stereotypical examples of the Hero archetype include Alexander the Great, Joan of Arc, military forces, and a Medieval Knight. Positive attributes of the Hero are bravery, goal-oriented, independence, honesty, and persistence. Negative attributes are that the Hero can be myopic, narcissistic, over-confident, boastful, and detached from the world. The Hero is probably more written and spoken about than any other archetype/symbol. He/she is on a perpetual quest, working towards a large reward (e.g. a Princess in a tower, hidden treasure, etc.). He/she must vanquish some powerful, opposing force (e.g. a dragon, armies, etc.) in order to reach the reward. Heroes can become too focused on the reward and lose sight of the consequences of their behavior in the present. They must perform the quest by themselves, and in so doing place their own judgment and well-being above all others'.

Wise Old Man: Some stereotypical Examples of the Wise Old Man include Gandhi, Martin Luther King, Jr., Confucius, Merlin, and a male lion. Positive attributes of the Wise Old Man are foresight, perception, rationality, resourcefulness, and fathomless intelligence. Negative attributes are that the Wise Old Man can be harsh, controlling, and manipulative, have a lack of empathy, and appear to be ethereal or otherworldly. The Wise Old Man is often seen as the source of knowledge and understanding of the world, and is often looked to when all potential solutions to a problem have been tried and failed. The Wise Old Man has the unique ability to see the truth of a situation before others are even aware of its existence. This can cause him to be extremely forceful and demanding of those around them. He can feel superior to the rest of the world, resulting in becoming a judgmental and potentially evil force in the world.

Trickster: Some stereotypical examples of the Trickster include Puck (from Shakespeare's Midsummer's Night Dream), the school bully, a court jester, and clowns. Positive Attributes of the Trickster are humor, entertainment, spontaneity, light-heartedness, and self-deprecation. Negative attributes include dishonesty, mean-spiritedness, violent behavior, sadistic behavior, and immaturity. The Trickster can be one's best friend or worst nightmare. He/she has the ability to find humor in anything and keep everyone's spirits uplifted. However, this same ability can be turned around to find humor at someone else's expense. The Trickster sometimes takes extreme pleasure in making other's lives miserable, without caring that they are doing it for their own selfish pleasure.

The invention operates on the premise that a consumer typically cannot adequately verbalize their preferences for a product, or explain what they desire in a product in a straightforward way, but that the use of symbols can provide to them a means to reveal what their inarticulable preferences are for a particular product or service.

The symbols employed in the present invention are used to tap into the brain's hardwiring, revealing consumers' preferences that the individual cannot normally articulate in a rational, linear manner. Combinations of two or more symbols can often be found in an individual. However, symbols are typically consistent amongst individuals, and are different for different categories, products, brands, etc. Indeed, symbols representing archetypes typically serve as a “blueprint” for all communication efforts.

The invention is typically used with individuals, in particular individual consumers, who are part of a larger group of people. The process is typically overseen by a marketing moderator (“moderator”) and a psychological analyst (“analyst”), and is essentially comprised of the following. First, individual(s) are notified by the moderator that the process is to be applied to a chosen concept or a product for future development. Next, the moderator asks the Respondent a question, or series of questions, related to the concept or product for future development, and a first archetypal sort is performed in which each individual Respondent chooses from a first set of images, with the directive in mind. With this sort, the analyst can obtain a very broad idea of the character of the emotional drivers which are present in the individual(s). Next, a second set of images is sorted in relation to the images chosen during the first sort. This provides sub-typing of the primary archetypes, and dimensionalizes and builds upon the primary information obtained to reveal a complete package of the emotional “must haves” that the individual(s) believe the concept or product should embody.

The invention typically employs six primary archetype categories, or symbols, as defined above: (1) Mother, (2) Father, (3) Child, (4) Hero, (5) Wise Old Man, and (6) Trickster. However, there are an infinite number of permutations that can be associated with these archetypes. The invention is best utilized when performed by a moderator with expertise in marketing and an analyst trained in psychology. That is, the “sort” revealed by the individual or group under study typically depends on the Respondents receiving the proper moderator directives (i.e. properly explaining the subject under consideration) and the analyst's psychological interpretation of the images/symbols which they have chosen. A moderator who is trained in marketing along with an analyst experienced in psychology, specifically Jungian archetypal theory, are best suited to carry out the system and method described herein.

More specifically, the process is begun by placing before an individual consumer, or group of individuals, a series of images. The invention typically employs the following first set of twenty-four (24) images, each of which symbolize a specific archetype, which is listed in parentheses next to each symbol: a butterfly (Child), a cane (Wise Old Man), a church (Mother), the Earth (Mother), an elephant (Wise Old Man), fireworks (Child), a family on a fishing boat under the sun (Child, Mother or Father), a forest (Mother), a hammer (Father), a Jack-in-the-box (Trickster or Child), a joker's crown (Trickster or Wise Old Man), a power glider (Hero), a knight (Hero), a lighthouse (Father), a lion (Wise Old Man or Hero), a monk (Wise Old Man), the Moon (Mother), the ocean (Mother), an owl (Wise Old Man), a shield (Hero), snow with a swing in background (Child), a statue (Hero), the sunrise (Father), and a telescope (Wise Old Man or Hero).

Typically each image is placed on its own separate card, similar to a playing card. In a preferred embodiment, the image is a photographic image. However, the specific vehicle of presentation of the image can vary, as long as the image is an accurate depiction of the intended symbol.

To begin the exercise, an individual (or individuals) is given a directive, i.e. they are asked to think about a particular subject or topic, such as a business category, event, product, food, word, phrase, feeling, etc. For example, the moderate can say: “I want you to think about cookies, think about what they look like, smell like, feel like, and taste like.” Respondents are then told to quickly sort through the first set of images, without putting too much cognitive thought into it, and choose images which they believe somehow relate to their thoughts and feelings regarding the subject under consideration. The Respondents are told that it doesn't matter if they can explain why or how an image relates to the topic, but that it only matters that the image somehow makes them feel related to how they also feel about the particular topic. The chosen images are then placed within a “Keep” pile, and those images that were not chosen are placed in a “Discard” pile. This is known as the first sort of the first set of images.

Next, the individual is instructed by the moderator to choose a particular number of images (typically between 3-6 images) from the Keep pile that had the most meaning to them. However, if an individual has initially placed only one or two images in the Keep pile, they are instructed to keep all of their images. The moderator then asks each Respondent/individual to describe each image they placed in their Keep pile and also to describe (if they are able) the reason(s) why they chose to keep each particular image in their Keep pile.

Comments made to the moderator about each image are recorded and documented by the analyst in order to help accurately classify into which category each Respondent is placing the image. This classification is done by evaluating the Respondents' comments about each image in relation to which of the categories the image may fit into: (1) Mother, (2) Father, (3) Child, (4) Hero, (5) Wise Old Man, and (6) Trickster. The total number of images representing each category is tallied for each group of individuals.

Next, according to the total number of images chosen for a specific category, the analyst determines which type of “symbology” has been revealed by the Respondents. That is, the analyst typically will determine whether the Respondents reveal a “dominant,” “dominant mixture,” “undefined,” and/or “muted” symbology, according to the number of images chosen per category. All other categories are considered insignificant.

The dominant symbology expressed by the Respondent(s) is defined as the one particular category in which the chosen images fall under more often than any other category. The dominant symbology represents the overall feelings or emotions that the individuals have about the particular topic the moderator asked about in the directives.

Where a dominant symbology can not be established because there are two categories sharing the most images assigned to them, the two categories are said to have a “dominant mixture” of categories. When a dominant mixture is seen it is often in the form of one symbol related to the other. A typical dominant mixture encountered is a Mother/Child symbology, because the Mother has something to devote herself to (her child) and the Child feels protected and loved (by the Mother). When the dominant symbology is mixed in this manner, the moderator typically will ask further questions so that the psychological analyst can attempt to determine what the mixture of symbologies means. For example, if Respondents reveal a Hero/Wise Old Man symbology, the analyst may understand that the Respondents' responses to a particular subject under consideration not only reveal emotions related to a quest (Hero), but also that feelings about wisdom (Wise Old Man) are related to this quest. It is typically rare to see a dominant mixture of symbologies, but when a dominant mixture occurs the psychological analyst should focus on how these two symbols are interacting in order to accurately determine the emotional hardwiring being revealed by the Respondents.

If there are three or more categories sharing the most images assigned to them, these categories are said to have an “undefined symbology.” Undefined symbologies are usually seen when the subject is related to a service/product that is new to the market and thus unknown to most consumers, or has not otherwise been developed in the Respondents' minds into any kind of emotional identity. If this is the case, then the marketing moderator will understand that the service/product has the opportunity to position itself however it would like, typically because there are currently no emotional expectations regarding that product on the part of the Respondents.

If any other category or categories were chosen more than twice, but not enough to be considered the dominant category, this category is said to have a “muted symbology.” The presence of a muted symbology allows the psychological analyst to better understand the overall emotional hardwiring that the Respondents possess regarding the topic under consideration. For example, if the subject is about the Respondent's preferences when buying a new car, a 65 year-old male Respondent may select images that reveal a Father as the dominant symbology with a Child muted symbology. The analyst can typically interpret these symbologies to mean that the 65 year-old male Respondent prefers to purchase a car at an established dealership, mainly because he desires quality for his money, but also because he wants to enjoy and appreciate the upper class feel of the dealership and its products.

Typically it is rare to find only a dominant symbology without also having a muted symbology, because human emotions are often multifaceted. The muted symbology thus appear to provide the moderator and analyst with a means to capture the entire emotional “picture” revealed by the Respondents' choices of images, and to make more precise determinations regarding the preferences of the Respondents concerning a particular product or service under consideration. This in turn provides insight to a marketer or manufacturer of a potential product regarding future communications, advertising, selling options, etc. to be aimed at consumers.

The dominant, dominant mixture, undefined and muted symbologies can also be distilled down further to individual sub-types. That is, each of the six categories of symbology, with the exception of the Trickster, can be further broken down into four distinct sub-types. As a non-limiting example, the category of Child can be broken down into the Mysterious Child, Wondrous Child, Overwhelmed Child and Mischievous Child. This is accomplished by next presenting the Respondent with a second set of standardized images.

The second set of images is not connected to specific archetypes or categories, as the first set of images is. Rather, the second set of images is used to help dimensionalize, or sub-type, the dominant symbologies which were determined from the first set of images. The purpose of sub-typing the categories is to get a more detailed understanding of how the Respondents felt about the topic of the exercise, and how these feelings may influence their judgments, either in a positive or negative way, when they are exposed to any type of communication or advertisement related to this particular topic.

The second set of standardized images typically includes the following second set of twenty (20) images: a roller coaster, a rose, a pig in slop, a roaring tiger, a deserted tropical island, a shining star, an eagle, a hurricane cloud formation, a king's crown, an oriental garden, a basket of grapes, a mountain peak, a cave door, a Trojan helmet, a sword, a black panther, a bolt of lightening, a Grecian pillar, a gavel, and a flame.

The first and second set of images disclosed above can be assembled and sold as a kit for use in determining consumer preferences. Typically the kit can include the first set of images (in which each image in the first set of images represents at least one archetype, the second set of images (in which each image in the second set of images is adapted to relate to at least one archetype), and directions for using the set of symbolic images. Typically the kit is to only be used by a moderator trained in marketing and an analyst trained in psychology, and typically both the moderator and the analyst should be familiar with symbology and Jungian Archetypes.

### EXAMPLE

The following paragraphs provide an example to help illustrate how the invention can be used to determine consumer preferences. The primary objective of the following example is to determine what will make the car-buying experience better at Dealership X, as compared to any of its competitors.

Background: Through qualitative research, Dealership X has determined that consumers generally face the car-buying experience with a certain degree of anxiety and trepidation. It is believed by car Dealership X that consumers will delay purchasing a car at a dealership because of their discomfort with the current experience, and that dealerships are losing business to online venues. Consequently, Dealership X decided that if they could make the car-buying experience more comfortable for consumers, then they would sell more cars. The purpose of the exercise is therefore aimed at determining what consumers think is uncomfortable about the current car-buying experience, and what is needed to make buying a car at Dealership X more customer-friendly.

At the outset a group of Respondents representing potential car-buying consumers is assembled, the number of Respondents in a group typically ranging between one and six individuals, and each Respondent in the group is asked to sort through the first set of symbolic images (24 total), and then the second set of symbolic images (20 total), as described above. The method of the invention is performed three times in this particular example, according to each of three separate directives which are given by the moderator. The three separate directives are the following: (1) Think about the last time you bought a car from a dealership, and choose images that connect with the feelings that you had then; (2) Think about how you feel now about going into a dealership to buy a new car, and choose images that connect with the feelings that you have now; and (3) Think about the ideal car-buying experience that you would prefer to have in a dealership, about how you would like to feel during that visit, and then choose images that connect with the feelings that you would like to experience when buying a car.

Each individual Respondent in the consumer group then proceeds under the direction of the moderator, one directive at a time, through the method of the invention. The method is typically conducted and analyzed in the exact same manner each time. As noted above, initially each Respondent is given the first set of symbolic images (24 total) and asked to quickly sort through the images and choose those which they believe somehow relate to their thoughts and feelings regarding the directive under consideration. The Respondents are told that it doesn't matter if they can explain why or how a particular image relates to the topic, but that it only matters that the image somehow makes them feel related to how they also feel about the particular directive.

Each Respondent places their choices from the first set of images into two piles: a Keep pile that contains images that somehow correspond to the feelings they have regarding the directive under consideration, and a Discard pile that contains all the images that did not correspond to those same feelings. Next, each Respondent is asked to narrow down their Keep pile to a certain number of images (Respondents are almost always asked to narrow their choices down to 2-5 images) that most closely matched their feelings about the car dealership directive.

Each Respondent is next asked by the moderator to spread their chosen 2-5 images out in front of them, and explain why each particular image corresponds to their feelings about the dealership directive. Each image typically has a letter permanently marked in the corner thereof, and Respondents are typically asked to refer to the letter of the image, along with explaining what the image is a picture of, to insure that they are recorded correctly by the analyst. Typically the letters in the corners of the images represent the archetype symbolized by that image (for e.g., a=child; b=mother; c=father; d=hero; e=wise old man; and f=trickster.) The moderator then typically questions each Respondent about their choice of pictures and the analyst takes notes, recording the letters of the pictures chosen and the comments associated with the individual pictures. While a qualified person trained in both marketing and psychology can perform as a single moderator of the method of the invention, typically two qualified people are present, i.e. a marketing moderator and a psychological analyst, and they typically divide the duties, with the marketing moderator devising and asking questions and the psychological analyst taking notes and determining symbologies. Both the moderator and the analyst then confer to determine consumer preferences and make final recommendations to the marketer/manufacturer of the service/product.

All of the Keep pile images from the first set of images are tallied, with the analyst taking notes. For example, if there were six Father images chosen, four Wise Old Man images chosen, one Child image chosen, and one Mother image chosen, then the Father is the dominant symbology, and the Wise Old Man is a muted symbology (chosen more than twice, but not enough to be considered the dominant category). The results obtained are compiled the same way for all three of the directives noted above.

It is notable that there are some images from the first set of images which can relate to two or more different archetypes. These include the following images: a family on a fishing boat under the sun (Child, Mother or Father), a Jack-in-the-box (Trickster or Child), a joker's crown (Trickster or Wise Old Man), a lion (Wise Old Man or Hero), and a telescope (Wise Old Man or Hero). Before proceeding to the second set of images, the Respondents' comments which are associated with these images first need to be analyzed to determine what archetype present in that image was being described by the Respondent. For example, if a Respondent chose the image of the family on a fishing boat under the sun (able to represent the Child, Mother or Father), the moderator will determine if they referred to the family in the boat (Child archetype), the water (Mother archetype), or the sun (Father archetype) according to the comments they made about the image. That is, the Respondent's focus on a specific part of that image dictates to the moderator which archetype was at play.

Once each Respondent has explained the reasons behind the images they chose in the first set of images, they are then asked to view the second set of symbolic images (20 total) and sort these images into two piles (Keep and Discard) as well. This time, however, they are instructed to choose images from the second set according to the feelings they had when they sorted the first set of images, the final Keep pile of which is still in front of them on the table. Respondents are asked to keep all of the images from the second set of images that somehow relate to the 3-5 images previously chosen from the first set of images. If not automatically done, the Respondents are typically asked to place the images chosen from the second set of images under one of the images chosen from the first set of images, according to what they feel most closely matches the feelings they had when they chose that image from the first set.

For example, a Respondent may choose the “power glider” (representing the Hero) from the first set of images and place the “mountain peak” and the “roller coaster” from the second set of images under the “power glider” because they most closely associate these images with it. If an image from the second set fits with more than one image from the first set, the Respondent is asked to simply explain how that image fits with each of the corresponding images from the first set. Respondents are then asked, individually, how the pictures chosen from the second set of images relate to the picture(s) from the first set of images.

The comments made by Respondents about the second set of images would then be recorded and referred to in order to determine what characteristics or sub-type of the archetype the Respondents were feeling when they chose from the first set of images. Recall our example above, in which, after viewing the first set of images, it was determined that the Father was the dominant category and the Wise Old Man was the muted category. Therefore, if there were three Respondents, all of which chose the image of the hammer (representing the Father archetype) from the first set of images, and two of these Respondents chose the roaring tiger and one chose the gavel from the second set of images to fit with the hammer, the analyst will then look to the comments that each Respondent made about the tiger and the gavel to determine how they felt about the Father archetype being expressed.

For instance, if the Respondents said they felt like they were being stalked when they saw the tiger picture and they felt like they were being judged when they looked at the gavel, the psychological analyst would determine that this group of Respondents felt that a car dealership is represented by a Father archetype that is being expressed as sneaky, judgmental and aggressive. This Father archetype is a sub-type known as the “Dangerous Father,” which is explained in more detail below. This same procedure would be used to analyze the Wise Old Man as the muted category from the second set of images. Again, this same procedure would be used for each of the three directives.

The sorting of images is usually done for multiple groups of Respondents. When this occurs, the analyst looks for the commonalties between the Respondent groups as far as their choices are concerned. A typical result found is that almost the exact same symbologies are chosen to represent the same archetypes between groups. When different symbologies are chosen between groups, it strongly suggests that the groups represent different segments of the population. For instance, if the aforementioned Father symbols were expressed by a group of teenaged girls, versus a group of 65 year-old men, the results from the choices of the second set of images might reveal that the teenaged girls choose the roaring tiger and gavel pictures, which express the Dangerous Father sub-type. In contrast, the 65 year old men may choose the king's crown (associated with power and prestige) and the Grecian pillar (associated with stability and longevity) pictures to describe how they interpreted those images, which express the Ambitious Father sub-type.

In other words, when two different Respondent groups choose a different sub-type of the dominant symbology for the same directive, then the analyst can anticipate that something about these groups of people is different, and that perhaps these two groups of people should be targeted by the marketer in different ways. However, although the sub-type of the dominant symbology may differ among different Respondent groups, typically a set of directives reveals the same dominant symbology no matter what segment of the population is being analyzed. Thus, it is apparent that the method of the present invention taps into the same emotional brain hardwiring in all groups of people, and not just in particular segments of the population.

However, if there are inconsistencies between groups, the method of the invention provides the ability to look at the individuals within these groups to determine which Respondents are revealing feelings and emotion similar to the whole group, and which are feeling differently. Doing this can help the psychological analyst to determine if the inconsistencies are a result of an unusual individual or the result of several individuals being in a different segment of the population (this is determined when all the individuals who feel differently are feeling the same way as one another). So, if all of the Respondents in a group revealed a Hero dominant symbology and a Child muted symbology, except for three or four individuals who revealed a Mother dominant symbology and Wise Old Man muted symbology, the moderator and the analyst can assume that these “different” Respondents fit a different segment and were thus sorting like each other but not like the rest of the Respondents. This is very rare, but, when it happens it typically has resulted in providing a powerful learning tool that usually results in a different outlook regarding the subject/product/service under consideration.

The following are the four different sub-types each of the Mother, Father, Child, Hero, and Wise Old Man, as used with the invention. As mentioned above, it is noteworthy that the Trickster is not divided into sub-types. This is because the Trickster has only two sub-types, it is considered to be either benevolent or malicious, and this classification can typically be discerned from the first set of images.

Selfless Mother: Pros: Nurturing, hind, Flexible, Patient; Cons: Selfless, Intimidated, Easily Manipulated, Easily Hurt. The mother everyone wants to have: she is a warm presence that is able to adapt to situations extremely easily. She is very focused on her family and makes sure their needs are taken care of before her own. She rarely is angry and prides herself on making others feel accepted and happy. Her major downfall is that she can be taken advantage of because of her focus on others wellbeing over her own. She is intimidated by her power and is afraid it could take her over if she allows it to come out. Therefore, she is extremely hesitant to use this power and can be seen as a pushover. Her self worth is wrapped up in her family and she can become lost because she has never established herself as an individual.

Cold-Blooded Mother: Pros: Predictable, Smart, Can be loving, Influential; Cons: Powerful, Calculating, Scary, Evil. This expression of the mother is the scariest mother of them all. She prides herself on her power and waits for the opportune moment to use it This expression of the mother is one that needs to be respected and closely watched. It is in everyone's best interest to make sure she is happy so she will not see them as a threat. This mother will watch out for her family if they allow her to be in charge and obey what she commands. If one stays on her good side by obeying her, her reactions are predictable. Her way of dealing with problems is to hit her opponent's weakest point at the most opportune time, resulting in the most possible damage with the least amount of effort. This is what makes her so scary. She is extremely confident in her abilities and will not hesitate to use her power if she wants to.

Traditional Mother: Pros: Warm, Loving, Helpful, Prepared; Cons: Clingy, Worrisome, Obsessive, Myopic. This expression of the mother puts her needs behind those of her family. However, if she feels someone she cares about is in danger or unprepared she will put her feelings and judgment above those of other people. In this way she can exert her power to make others do what she feels is right. This expression of the mother is very knowledgeable because it is her way of making sure everyone is safe. She can use this knowledge to help guide those who approach her for advice. However, this knowledge is a double-edged sword because it can make her feel her opinion is more valid than others and cause her to become very judgmental. This mother worries about what others think of her and can thus tie herself up in knots by worrying about others' impressions of her while she judges them.

Unpredictable Mother: Pros: Helpful, Concerned, Thorough, Tough; Cons: Holds grudges, Powerful, Judgmental, Scary. This mother is concerned about her family and will help them when needed. However, this mother is driven by fear and thus can react to situations with fear and/or with anger. This mother's default response is to come out with guns blazing and ask questions later. She will fight anyone, anywhere, anytime and will not stop until she feels she has eliminated any chance of a threat to her or her family. She is never comfortable because she worries so much and can be extremely difficult to be around. She is constantly trying to control people and situations to ensure that everything will go according to plan. Changes to her plans can cause this mother to implode and lash out at those she sees as responsible for her discomfort.

Aware Father: Pros: Adaptive, Loyal, Caring, Intelligent; Cons: Controlling, Worrisome, Stubborn, Aggressive. This expression of the father is a tough guy tempered by a huge heart. The Aware Father makes it a point to look out for those he cares about and will do so no matter the cost. This tenaciousness can become detrimental, however, if it is manifested out of fear. This father will fight whatever he has determined is a threat to his family or loved ones even if the “threat” never was intending to do any harm. This father uses his developed intelligence to stay one step ahead of his children and can use this ability to stay one step ahead of a perceived threat as well. Even though this aggressive streak does exist in this father, his default position is one of kindness and patience, not of anger and is therefore a very benevolent figure.

Ambitious Father: Pros: Driven, Focused, Prepared, Rational; Cons: Emotionally distant, Selfish, Myopic, Distracted. This expression of the father feels it is his job to advance himself and hopefully advance his family at the same time. The Ambitious Father is focused on giving himself and his family the best of what life has to offer. However, he can do this at the expense of creating a warm and loving environment for himself and his family. This father prides himself on being rational and results-oriented. He, therefore, can be a very harsh person that is unconcerned with the feelings of those around him. He can be extremely helpful if he feels his best interest and another's best interest are somehow intertwined. This expression of the father isn't necessarily bad, he is just so externally focused that he can often miss the most important parts of himself and his family.

Explosive Father: Pros: Fun, Spontaneous, Lives in the moment, Loving; Cons: Unpredictable, Lack of accountability, Intense, Reckless. The Explosive Father is the life of the party. His mission in life is to make sure that himself and everyone around him is having a good time. He loves his family very much and will protect them from influences he feels are emotionally damaging. All of this fun can come at a huge price, however, and this expression of the father can be extremely (though unintentionally) dangerous. He so wants to have fun that he can forget about making sure something is safe before he exposes himself (and everyone else) to a potentially dangerous situation. It seems that he just doesn't understand that a situation could pose a threat to himself and/or his family and thus sails headlong into potentially dangerous waters. Fundamentally, he is a loving figure that cares very much for his loved ones. He just has a hard time not getting caught up in the moment even when it is dangerous.

Dangerous Father: Pros: Self-assured & Pro-active; Cons: Ruthless, Cunning, Sinister, Powerful. This expression of the father is by far the most frightening of all. He can range from a distant and cold presence to a sociopath. This father does not care for his family or anyone close to him. He feels anger is the only emotion and that everything else called “emotion” should be called “weakness.” If anyone attempts to control him he will attempt to battle them into submission even if it costs him dearly. Retribution against those who don't show him respect by submitting to him is his sole purpose for existing. This is a fundamentally sad and dangerous figure that should be avoided.

Wondrous Child: Pros: Pure, Appreciative, Happy, Serene; Cons: Oblivious, Sedentary, Easily Manipulated, Vulnerable. This expression of the child is extremely peaceful and kind. They look at the world as a safe place to be admired and appreciated. They can be seen as living with their “head in the clouds” and can be severely lacking in ambition because they feel so comfortable with themselves and their world. This child trusts implicitly and can get themselves into serious trouble by trusting the wrong people. If taken advantage of too often, they can become cynical towards the world, but this is a fairly rare occurrence.

Mischievous Child: Pros: Funny, Happy, Vibrant, Ever-evolving; Cons: Sneaky, Mean, Selfish, Manipulative. This expression of the child is the one who always seems to be getting themselves in trouble for talking when they are not supposed to be, or for running in the hallway at school. This child is always looking to have fun and is always pushing the boundaries of what is acceptable to see if they can get away with it. They can be extremely persuasive and can use this talent to manipulate others into doing their bidding. A major downfall of this child is that they can become so self-centered that they can be bullies or juvenile delinquents. If their selfishness is controlled, they will be seen as the class clown or the life of the party because of their willingness to have fun in newly invented ways.

Mysterious Child: Pros: Intuitive, Sensitive, Loyal, Understanding; Cons: Dark, Scary, Vengeful, Brooding. This expression of the child is very sensitive and can pick-up on the needs of others very quickly. They are very caring and can use their intuition to help those in need. They are quiet and tend to have a small group of people to whom they are extremely close and loyal. They can have a dark side to them that they have a hard time dealing with. They can be extremely happy or hurt without anyone realizing how they feel. Thus, they can be unpredictable and dangerous to those around them without anyone even being aware of a problem. This child prides him/herself on their intuitive ability and takes a long time to trust someone.

Overwhelmed Child: Pros: Perceptive, Sensitive, Multi-tasking; Cons: Unpredictable, Angry, Selfish, Myopic. This expression of the child is focused solely upon themselves because they feel threatened. They are acutely aware of their environment, yet can only focus on one piece of their environment at a time. Thus, they are constantly being bombarded by information they are unable to fully assimilate. They have developed the ability to multi-task but do it at the expense of completing a task at anything but a satisfactory level. This child's world is seen as dangerous and in desperate need of predictability and stability. This child spends all of his/her time just trying to keep their head above water and will do whatever they feel is necessary to make sure they survive.

Reluctant Hero: Pros: Humble, Simple, Trustworthy, Honorable; Cons: Almost helpless, Unprepared, Naive, Vulnerable. The Reluctant Hero is a figure that is very easy to become attached to. This expression of the Hero is very vulnerable and it seems that they will surely be defeated by an obstacle on their quest. Yet, the Reluctant Hero always seems to find some internal power that enables them to overcome the obstacle they are facing. This expression of the Hero is a simple figure who is battling their fear of being injured and/or not being able to finish their quest. This is the “underdog” that we all root for, the “Cinderella team” that magically wins the championship. This figure is one where the whole is greater than the sum of its parts. This Hero is very susceptible to manipulation because the Reluctant Hero desperately needs guidance and will sometimes place his or her faith in those who mean nothing but harm.

Misguided Hero: Pros: Prepared, Determined, Focused, Tenacious; Cons: Extremely stubborn, Extremely myopic, Needs guidance, Angry. The most common example of the Misguided Hero is Don Quixote. This expression of the Hero truly believes they are doing what is required of them and they do it to the best of their ability. The major downfall of this Hero is they lack the ability to sense when they have diverted from their original quest. They become like an unguided missile just looking for something to blow up. This can be seen in the hardcore activists that are so determined to stop an opposing force that they put themselves and others at risk while trying to do so. Thus, the Misguided hero can be a very lovable figure (i.e. Don Quixote) or can be a potentially dangerous figure (i.e. Anarchist).

Frustrated Hero: Pros: Capable, Tough, Focused, Determined; Cons: Bitter, Self-destructive, Angry, Sad. The Frustrated Hero is a figure who has run up against an obstacle that they cannot seemingly overcome. They feel they have done their best to conquer this obstacle but have been unsuccessful. This Hero then becomes a mixture of an upset, angry, and bitter figure. The Frustrated Hero begins to doubt his or her abilities and turns their aggression on themselves and their perceived failure. The Hero in general is not known for their coping skills, and this expression of the Hero is no exception. They desperately need guidance and recontextualization of their circumstances by some outside party. Once their obstacle is reframed, they almost always find a way to conquer it and continue on their quest. Yet, they have a hard time accepting guidance from someone else because they are so independent and thus can get themselves into a downward spiral that they cannot pull themselves out of.

Mythical Hero: Pros: Honest, Courageous, Loving, Aware; Cons: Have to be selfless, Lonely, Never-ending quest. The most prevalent examples of the Mythical Hero can found in the comic books and movies of Batman and of Superman. The Mythical Hero is so powerful that the job he or she does for the world cannot be done by anyone else. Thus, their duties are ever present and relegate this Hero to his or her set vice. This sacrifice to the greater good means this Hero can be very lonely and wish for something other than their quest. Even though there are definite downsides to these duties, this Hero is written about so often (i.e. the solider who runs into gunfire to save his comrades, the leader who faces death threats to continue on their quest for peace, etc.) because we all aspire to have the courage to step up to a challenge like this if it should ever come our way.

Rational Wise Old Man: Pros: Kind, Peaceful, Part of the world, Helpful; Cons: Often ahead of their time, Misunderstood, Vulnerable. The Rational Wise Old Man is the grandparent everyone wants to have. This figure is extremely warm, kind, helpful, and genuine. They want nothing but the best for everyone and do what they can to make sure this happens. The Rational Wise Old Man's major downfall comes from the outside world being fearful of their power. Religious figures (i.e. Jesus, Mohammed, and Buddha) almost always fall into this category. They risk their lives in order to bring guidance to others. This is a very rare figure to find in society and is one that always donates a tremendous amount of respect from those exposed to them.

Mystical Wise Old Man: Pros: Learned, Dedicated, Independent, Thorough; Cons: Distant, Unclear, Extremely Complex, Content. This expression of the Wise Old Man is often seen in the world of academia when accomplished professors attempt to teach. This expression of the Wise Old Man is very focused on learning and not at all focused on teaching this knowledge in a useful way. The Mystical Wise Old Man is extremely helpful if the party seeking help can wade through the plethora of information provided by the Wise Old Man. He/She is a very patient figure who truly does want to help others understand. Yet, this expression of the Wise Old Man is not grounded enough in the “real world” to give direct instruction or advice. Thus, this expression of the Wise Old Man can cause others to become frustrated and feel stupid for not understanding what was said to them.

Pushy Wise Old Man: Pros: Realistic, Direct, Clear, Quick; Cons: Judgmental, Harsh, Intolerant, Angry. The Pushy Wise Old Man is a crotchety figure that is very quick to arrive at decisions and even quicker to tell others what to do. This expression of the Wise Old Man is very intelligent and attempts to use his/her knowledge to help others. The major downfall of this figure is their impatience and harshness. Yes, the Pushy Wise Old Man can see what needs to be and can articulate in a way that others can understand it. However, if the party receiving the advice doesn't perform as well/quickly/thoroughly/etc. as the Pushy Wise Old Man thinks they should, he will lash out at them. The “tough love” approach is extremely appealing to this figure and he/she uses whenever they feel someone isn't meeting the standard set for them by the Pushy Wise Old Man. Therefore, this expression of the Wise Old Man is one that is approached when: 1) they are the only option to get the necessary information; or 2) the party seeking the wisdom of the Pushy Wise Old Man also feels they need the discipline to go along with the wisdom (e.g. a martial arts student seeking out a tough sensei, or a recruit going to boot camp with a ruthless drill instructor).

Pompous Wise Old Man: Pros: Learned, Refined; Cons: Aloof, Condescending, Superior, Boastful. The Pompous Wise Old Man is easily seen in country clubs and club houses around the world. This expression of the Wise Old Man is smart and knows it. He/she looks down on anyone that doesn't have the same level of skill/knowledge as they have. The Pompous Wise Old Man values heritage over character, social perception over truth. Normally, this expression of the Wise Old Man stays far enough away from the “real world” to not have a significant effect upon it. However, if they are given a position of power in the “real world” they can become extremely egotistical and myopic. Therefore, the Pompous Wise Old Man isn't a threat to the average person as long as they are allowed to live outside of normal society and aren't looked to for advice and guidance.

The sub-types allow the analyst to accurately and specifically describe the emotions being felt by the Respondents. It should be noted here that the sub-types listed above are the most common ones typically encountered in the research that has been done to date, using symbology as a method. However, like any finite list of emotional material, combinations of these sub-types have been encountered, where certain aspects from two subtypes are being revealed by the Respondents. When this occurs, the combination of the two sub-types is typically used instead of attempting to force-fit the information into one sub-type.

The method of the present invention can be used in areas of psychological research in addition to marketing. For example, the present invention can be used in a psychotherapeutic setting as a way of determining a patient's inarticulable feelings regarding a traumatic experience, phobia, etc. It can also be used with child patients to help them describe how they feel about a certain experience they are otherwise unable to describe. In addition, it is anticipated that the present invention could be used to determine how people feel about a certain political candidate, piece of legislation, government policy, etc.

It is important to note that it is preferred to have a moderator experienced and trained in marketing directing the method of the invention and an analyst trained in psychology, for two main reasons; 1) an experienced analyst should know when it is necessary to probe for more details regarding the Respondents choices. If the analyst doesn't understand the symbology and the Jungian Archetypes of the invention, they will be unable to capture and contextualize the information; 2) the method of the invention can be used in a negative manner by an untrained or unscrupulous moderator in order to see into an individual's unconscious mind, possibly in order to manipulate the Respondent into doing something they have no interest in doing. The present invention is intended for use as a tool for creating a shared language between the manufacturer and the consumer, because such a shared language currently does not exist in the prior art. Thus, anyone employing this invention for market research should have the experience and the ethical accountability not to tap into the thoughts and desires of an individual in an attempt to manipulate someone into buying or using a product or service.

It is also typically preferred to use the invention in a manner in which groups of people are evaluated as a unit to determine general consumer preferences, rather than a single individual. The invention is also intended to require Respondents to reveal only thoughts and feelings specific to the task at hand. That is, the moderator should only ask very specific questions about the subject/products/services under consideration, in order to understand the logic the Respondents are using to reveal their thoughts about the product or service. A moderator who uses the method of the invention should understand that no subject other than the one the group has agreed to share should be explored. Additionally, the psychologically-trained and experienced analyst needs to listen to how the Respondents are describing the pictures that can have different archetypes (e.g. are they seeing water, sunlight, two or three people in the boat picture?). The analyst should also be sure the Respondents are describing their own feelings about the pictures, and not what the Respondent believes someone else might be feeling upon viewing a specific picture. One purpose of using the second set of images to sub-type the dominant symbology is to make the “decoding process” of the Respondents much more self-evident, not only for the analyst and moderator, but also for the marketer/manufacturer.

While the present invention has been illustrated by the description of embodiments and examples thereof, it is not intended to restrict or in any way limit the scope of the appended claims to such detail. Additional advantages and modifications will be readily apparent to those skilled in the art. Accordingly, departures may be made from such details without departing from the scope or spirit of the invention.

What is claimed is:

1. A method for determining consumer preferences, the method comprising the steps of:
a) providing a subject for at least one individual to concentrate upon;
b) providing the individual with a set of symbolic images;
c) instructing the individual to quickly sort through the symbolic images and to select images which relate to the subject;
d) instructing the individual to sort through the images selected in step (c) and to select a predetermined number of images which most strongly relate to the subject;
e) assigning each image selected in step (d) to one of a plurality of categories; and
f) determining a dominant category expressed by the individual according to the total number of images assigned to each category in step (e), wherein the dominant category has the most images assigned to it and thereby represents preferences the individual has about the subject.

2. The method of claim 1, further including the steps of:
g) obtaining and documenting verbal observations from the individual regarding each image selected in step (d); and
h) determining a sub-category of the dominant category according to the observations made regarding each image in step (g), whereby the sub-category provides a more detailed understanding of the preferences of the individual about the subject.

3. The method of claim 2, wherein step (h) comprises the steps of:
i. providing the individual with a second set of symbolic images;
ii. instructing the individual to quickly sort through the second set of symbolic images and to select images which relate to the images selected in step (d);
iii. obtaining and documenting verbal observations from the individual regarding each image selected in step (ii); and
iv. determining a sub-category of the dominant category according to the observations made regarding each image in step (iii), whereby the sub-category provides a more detailed understanding of the preferences of the individual about the subject.

4. The method of claim 1, wherein the method is conducted by a moderator trained in marketing and an analyst trained in psychology, and wherein both the moderator and the analyst are familiar with symbology and Jungian Archetypes.

5. The method of claim 1, wherein the subject is selected from the group consisting of a product line, a business service, a business group, an event, a location, a word, a phrase, and a feeling.

6. The method of claim 1, wherein the at least one individual is a group of individuals.

7. The method of claim 1, wherein the plurality of categories are selected from the group consisting of Mother, Father, Child, Hero, Wise Old Man, and Trickster.

8. The method of claim 1, wherein the predetermined number of images selected by the individual in step (d) is selected from the group consisting of 1, 2, 3, 4, 5 and 6.

9. The method of claim 1, wherein the set of symbolic images is selected from the group consisting of a butterfly, a cane, a church, Earth, an elephant, fireworks, a family on a fishing boat under the sun, a forest, a hammer, a Jack-in-the-box, a joker's crown, a power glider, a knight, a lighthouse, a lion, a monk, the Moon, the ocean, an owl, a shield, the snow with a swing in the background, a statue, the sunrise, and a telescope.

10. A method for determining consumer preferences for a product line or business service, the method comprising the steps of:
a) providing a subject for at least one individual to concentrate upon;
b) providing the individual with a first set of symbolic images;
c) instructing the individual to quickly sort through the first set of symbolic images and to select images which relate to the subject;
d) instructing the individual to sort through the images selected in step (c) and to select a predetermined number of images which most strongly relate to the subject;
e) assigning each image selected in step (d) to one of a plurality of categories;
f) determining a dominant category expressed by the individual according to the total number of images assigned to each category in step (e), wherein the dominant category has the most images assigned to it and thereby represents preferences the individual has about the subject;
g) providing the individual with a second set of symbolic images;
h) instructing the individual to quickly sort through the second set of symbolic images and to select images which relate to the images selected in step (d);
i) obtaining and documenting verbal observations from the individual regarding each image selected in step (h); and
j) determining a sub-category of the dominant category according to the observations made regarding each image in step (i), wherein the sub-category provides a more detailed understanding of the preferences of the individual about the subject.

11. The method of claim 10, wherein the method is conducted by a moderator trained in marketing and an analyst trained in psychology, and wherein both the moderator and the analyst are familiar with symbology and Jungian Archetypes.

12. The method of claim 10, wherein the subject is selected from the group consisting of a product line, a business service, a business group, an event, a location, a word, a phrase, and a feeling.

13. The method of claim 10, wherein the at least one individual is a group of individuals.

14. The method of claim 10, wherein the plurality of categories are selected from the group consisting of Mother, Father, Child, Hero, Wise Old Man, and Trickster.

15. The method of claim 10, wherein the first set of symbolic images is selected from the group consisting of a butterfly, a cane, a church, Earth, an elephant, fireworks, a family on a fishing boat under the sun, a forest, a hammer, a Jack-in-the-box, a joker's crown, a power glider, a knight, a lighthouse, a lion, a monk, the Moon, the ocean, an owl, a shield, the snow with a swing in the background, a statue, the sunrise, and a telescope.

16. The method of claim 10, wherein the second set of symbolic images is selected from the group consisting of a roller coaster, a rose, a pig, a roaring tiger, a tropical island, a shining star, an eagle, a hurricane cloud formation, a king's crown, an oriental garden, a basket of grapes, a mountain, a cave, a helmet, a sword, a black panther, a bolt of lightening, a pillar, a gavel, and a flame.

17. The method of claim 10, wherein the sub-category is selected from the group consisting of a Wondrous Child, a Mischievous Child, a Mysterious Child, an Overwhelmed Child, an Aware Father, an Ambitious Father, an Explosive Father, a Dangerous Father, a Reluctant Hero, a Misguided Hero, a Frustrated Hero, a Mythical Hero, a Selfless Mother, a Cold-blooded Mother, a Traditional Mother, an Unpredictable Mother, a Rational Wise Old Man, a Mystical Wise Old Man, a Pushy Wise Old Man, and a Pompous Wise Old Man.

18. A kit for use in determining consumer preferences, the kit comprising:
a) a first set of images, each image in the first set of images representing at least one archetype;
b) a second set of images, each image in the second set of images adapted to relate to at least one archetype; and
c) directions for using the set of symbolic images, wherein the kit is used by a moderator trained in marketing and an analyst trained in psychology, and wherein both the moderator and the analyst are familiar with symbology and Jungian Archetypes.

19. The kit of claim 18, wherein the directions comprise:
a) providing a subject for at least one individual to concentrate upon;
b) providing the individual with the first set of symbolic images;
c) instructing the individual to quickly sort through the first set of symbolic images and to select images which relate to the subject;
d) instructing the individual to sort through the images selected in step (c) and to select a predetermined number of images which most strongly relate to the subject;
e) assigning each image selected in step (d) to one of a plurality of categories;
f) determining a dominant category expressed by the individual according to the total number of images assigned to each category in step (e), wherein the dominant category has the most images assigned to it and thereby represents preferences the individual has about the subject;
g) providing the individual with the second set of symbolic images;
h) instructing the individual to quickly sort through the second set of symbolic images and to select images which relate to the images selected in step (d);
i) obtaining and documenting verbal observations from the individual regarding each image selected in step (h); and
j) determining a sub-category of the dominant category according to the observations made regarding each image in step (i), whereby the sub-category provides a more detailed understanding of the preferences of the individual about the subject.

20. The kit of claim 19, wherein the subject is selected from the group consisting of a product line, a business service, a business group, an event, a location, a word, a phrase, and a feeling,
wherein the plurality of categories are selected from the group consisting of Mother, Father, Child, Hero, Wise Old Man, and Trickster,
wherein the first set of symbolic images is selected from the group consisting of a butterfly, a cane, a church, Earth, an elephant, fireworks, a family on a fishing boat under the sun, a forest, a hammer, a Jack-in-the-box, a joker's crown, a power glider, a knight, a lighthouse, a lion, a monk, the Moon, the ocean, an owl, a shield, the snow with a swing in the background, a statue, the sunrise, and a telescope,
wherein the second set of symbolic images is selected from the group consisting of a roller coaster, a rose, a pig, a roaring tiger, a tropical island, a shining star, an eagle, a hurricane cloud formation, a king's crown, an oriental garden, a basket of grapes, a mountain, a cave, a helmet, a sword, a black panther, a bolt of lightening, a pillar, a gavel, and a flame,
and wherein the sub-category is selected from the group consisting of a Wondrous Child, a Mischievous Child, a Mysterious Child, an Overwhelmed Child, an Aware Father, an Ambitious Father, an Explosive Father, a Dangerous Father, a Reluctant Hero, a Misguided Hero, a Frustrated Hero, a Mythical Hero, a Selfless Mother, a Cold-blooded Mother, a Traditional Mother, an Unpredictable Mother, a Rational Wise Old Man, a Mystical Wise Old Man, a Pushy Wise Old Man, and a Pompous Wise Old Man.
